(19) United States
(12) Patent Application Publication
(10) Pub. No.: US 2017/0197228 A1
(43) Pub. Date: Jul. 13, 2017

(54) PRODUCT DISPENSING DIAGNOSTIC SYSTEM

(71) Applicant: AGCO Corporation, Hesston, KS (US)

(72) Inventors: Brady Bjornson, Hesston, KS (US); Craig Miller, Jackson, MN (US)

(21) Appl. No.: 15/400,114

(22) Filed: Jan. 6, 2017

Related U.S. Application Data
(60) Provisional application No. 62/275,943, filed on Jan. 7, 2016.

(51) Int. Cl. B05B 12/00

(52) U.S. Cl. CPC B05B 12/006

(57) ABSTRACT

A diagnostic system for a product-dispensing machine includes a plurality of nozzles, a hydraulic pump and a circuit coupled to the nozzles. The circuit includes tubular members, a pump, a screen, and a plurality of first components coupled to the tubular members. The plurality of first components includes a pump motor, a pump pressure transducer, a flowmeter, and a nozzle pressure transducer. The system includes an electronic control unit coupled to the circuit configured to receive inputs associated with a motor of the hydraulic pump and each of the first components and based on a combination of the inputs, determine whether one or a combination of the pump, the pump motor, the hydraulic pump, the hydraulic pump motor, the screen, the flowmeter, the nozzle pressure transducer, or at least a portion of the tubular members is causing values associated with the inputs to have a threshold difference from predetermined values.

### CROSS REFERENCE TO RELATED APPLICATION

This application claims the benefit of U.S. Provisional Application No. 62/275,943 filed Jan. 7, 2016, which is hereby incorporated by reference in its entirety.

### BACKGROUND OF THE INVENTION

Field of Invention

The present disclosure is generally related to mobile machines that dispense product and, more particularly, to a diagnostic system for product dispensing systems.

Description of Related Art

Mobile machines, such as self-propelled or pull-type sprayers, which dispense product, may come equipped with a circuit (fluid pathway) connection of a plurality of components, including a reservoir (e.g., tank), pump, strainers, and spray nozzles, among others. These components may degenerate and/or become plugged over time. Experienced operators have developed a knowledge base that enables their personal deterministic, reasoned approach to diagnosing issues with such product dispensing systems. However, a combination of attrition and economical pressures has resulted in a growing workforce of younger, and hence less experienced, operators that are often less capable in efficiently dealing with problems that arise with the product dispensing systems.

### BRIEF SUMMARY OF THE INVENTION

Briefly stated, the invention is directed to a diagnostic system for a mobile product dispensing machine. The system includes a plurality of nozzles, a hydraulic pump and a circuit coupled to the plurality of nozzles. The circuit includes tubular members, a pump, a screen, and a plurality of first components coupled to the tubular members. The plurality of first components includes a pump motor, a pump pressure transducer, a flowmeter, and a nozzle pressure transducer. The system also includes an electronic control unit coupled to the circuit. The electronic control unit is configured to receive inputs associated with a motor of the hydraulic pump and each of the plurality of first components and based on a combination of all of the inputs, determine whether one or a combination of the pump, the pump motor, the hydraulic pump, the hydraulic pump motor, the screen, the flowmeter, the nozzle pressure transducer, or at least a portion of the tubular members is causing values associated with the inputs to have a threshold difference from respective predetermined values, and provide feedback of the determination.

The invention is also directed to a method including receiving inputs corresponding to a pump motor speed, a hydraulic pump motor speed, pump pressure, flow, and nozzle pressure, and based on a combination of all of the inputs, determining which of a plurality of components is causing values associated with the inputs to have a threshold difference from respective predetermined values. The method includes providing feedback of the determination.

This summary is provided to introduce concepts in simplified form that are further described below in the Description of Preferred Embodiments. This summary is not intended to identify key features or essential features of the disclosed or claimed subject matter and is not intended to describe each disclosed embodiment or every implementation of the disclosed or claimed subject matter. Specifically, features disclosed herein with respect to one embodiment may be equally applicable to another. Further, this summary is not intended to be used as an aid in determining the scope of the claimed subject matter. Many other novel advantages, features, and relationships will become apparent as this description proceeds. The figures and the description that follow more particularly exemplify illustrative embodiments.

### BRIEF DESCRIPTION OF THE DRAWINGS

Many aspects of a product dispensing diagnostic system can be better understood with reference to the following drawings. The components in the drawings are not necessarily to scale, emphasis instead being placed upon clearly illustrating the principles of certain embodiments of the system. Moreover, in the drawings, like reference numerals designate corresponding parts throughout the several views.

FIG. 1 is a schematic diagram that illustrates an example mobile machine in which an embodiment of a product dispensing diagnostic system may be used.

FIG. 2 is a schematic diagram that illustrates a circuit of the mobile machine in FIG. 1 that comprises an embodiment of an example product dispensing diagnostic system.

FIG. 3 is a block diagram of an embodiment of an example electronic control unit used in the product dispensing diagnostic system of FIG. 2.

FIG. 4 is a schematic diagram that illustrates an embodiment of an example troubleshooting tree algorithmically used by the example electronic control unit of FIG. 3.

FIG. 5 is a flow diagram that illustrates an embodiment of an example product dispensing diagnostic method.

### DESCRIPTION OF EXAMPLE EMBODIMENTS

Certain embodiments of a product dispensing diagnostic system and method for mobile machines are disclosed that utilize inputs from plural select components within and/or associated with a circuit assembly (enabling a flow path for fluid) of tubular members to assess, in real-time, whether these and other components of the circuit are operating at or below an expected (e.g., optimum) efficiency, and to provide feedback to an operator to enable ongoing adjustments to compensate for wear, or unplug or replace, affected components. In one embodiment, inputs are collected directly or indirectly from a pump motor, a hydraulic pump motor, a pump pressure transducer, a flowmeter, and a nozzle pressure transducer and all of these inputs processed concurrently and in real time to make a determination whether one or a combination of components of the circuit (and components associated with the circuit) are causing values of those inputs to have a threshold difference (e.g., +/−a threshold tolerance) from respective predetermined values (e.g., expected values), and to also provide feedback of problems (or generally, status) of those affected components. For instance, a determination may be made that pump motor speed has decreased 10% from expected (e.g., historical or designed-for) speed, where 10% is an example (non-limiting) threshold level that when surpassed, prompts an evaluation of the cause and provision of feedback (e.g., an alert) to the operator. In some embodiments, there may be plural thresholds that, when surpassed, provide a progressive level of alerts ranging from minor to major (e.g., requiring an immediate action to address the problem, such as via replacing parts, ordering replacement parts, unplugging components, etc.).

Digressing briefly, and as explained in the background, current methods of assessing performance of product dispensing systems rely on the experience of an operator, who in turn relies upon readings of pump pressure, nozzle pressure, and obtainable rate as the indicator for components that are worn to the point of poor performance. However, such assessments are not based on a comprehensive or as-a-whole approach. For instance, one assessment process may determine that the rate is unattainable, where operation in the field requires adjusting the output to a higher than average rate, causing the mobile machine to traverse a field at a speed that is slower than desired to obtain the requested rate of dispensing of product, all while pump and/or nozzle pressures cannot be maintained. As another example, when rate or pump pressure is determined to be unobtainable, the operator makes adjustments to increase a higher than average rate of dispensing, while also slowing the mobile machine (again without being able to maintain pump and/or nozzle pressures). The operator may assess the nozzle pressure, and if it cannot be achieved, the operator causes the mobile machine to dispense product at a higher rate than average and slow the mobile machine to obtain the requested rate (again, without maintaining the nozzle pressure as required). The operator may also assess the deadhead pump pressure, where a stationary spray test is performed with all valves of the circuit shut so spraying is prohibited, and the pump is run to create a maximum pressure. Information is recorded and checked against the previous check to see if the corresponding value has dropped substantially. If the value has dropped substantially, the operator determines that the pump or pump motor has substantial wear and should be replaced. In contrast to current diagnostic methods, certain embodiments of a product dispensing diagnostic system receive plural inputs and through an automatic, operator-transparent process of elimination, assess in parallel those inputs according to a troubleshooting tree algorithm that comprises a matrix of inputs and assumptions of the cause of the problems in an on-going (continual) manner to quickly and efficiently deduce the cause of any problems and provide feedback to the operator to prompt the operator to fix or, in general, address the problem(s). Such a comprehensive diagnostic process may also prevent an improper assessment that is more likely when diagnostics do not take an as-a-whole approach.

Having summarized certain features of a product dispensing diagnostic system, reference will now be made in detail to the description of certain embodiments of a product dispensing diagnostic system as illustrated in the drawings. While embodiments of a product dispensing diagnostic system will be described in connection with these drawings, there is no intent to limit it to the embodiment or embodiments disclosed herein. For instance, though emphasis is placed on mobile machines such as a self-propelled liquid sprayer for the agricultural industry, it should be appreciated by one having ordinary skill in the context of the present disclosure that product of the same or other forms (e.g., solids, and not just liquids) may be dispensed from other mobile machines, including pull-type sprayers, liquid applications on planters, anhydrous toolbars, air seeders, pneumatic fertilizer spreaders (e.g., based off of air pressure or hydraulic pressure) or mobile machines from other industries (e.g., the construction industry, municipal industry, etc.). Further, although the description identifies or describes specifics of one or more embodiments, such specifics are not necessarily part of every embodiment, nor are all of any various stated advantages necessarily associated with a single embodiment. On the contrary, the intent is to cover all alternatives, modifications and equivalents included within the spirit and scope of the disclosure as defined by the appended claims. Further, it should be appreciated in the context of the present disclosure that the claims are not necessarily limited to the particular embodiments set out in the description. In some embodiments, features described for one embodiment may be combined with features of another embodiment.

Note that references hereinafter made to certain directions, such as, for example, “front”, “rear”, “left” and “right”, are made as viewed from the rear of a machine looking forwardly. Also, as suggested above, use of the term, product, is intended to include liquid and solid forms of product, including chemicals and/or water.

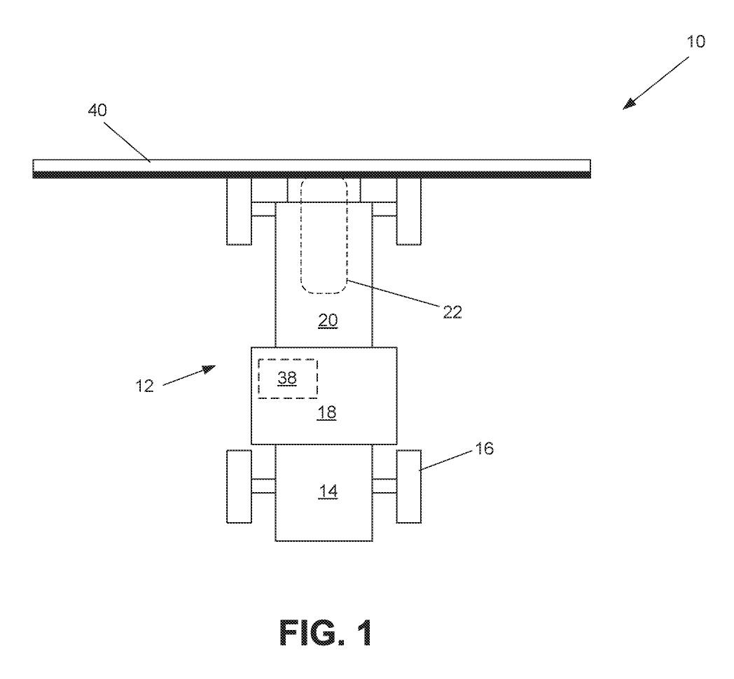

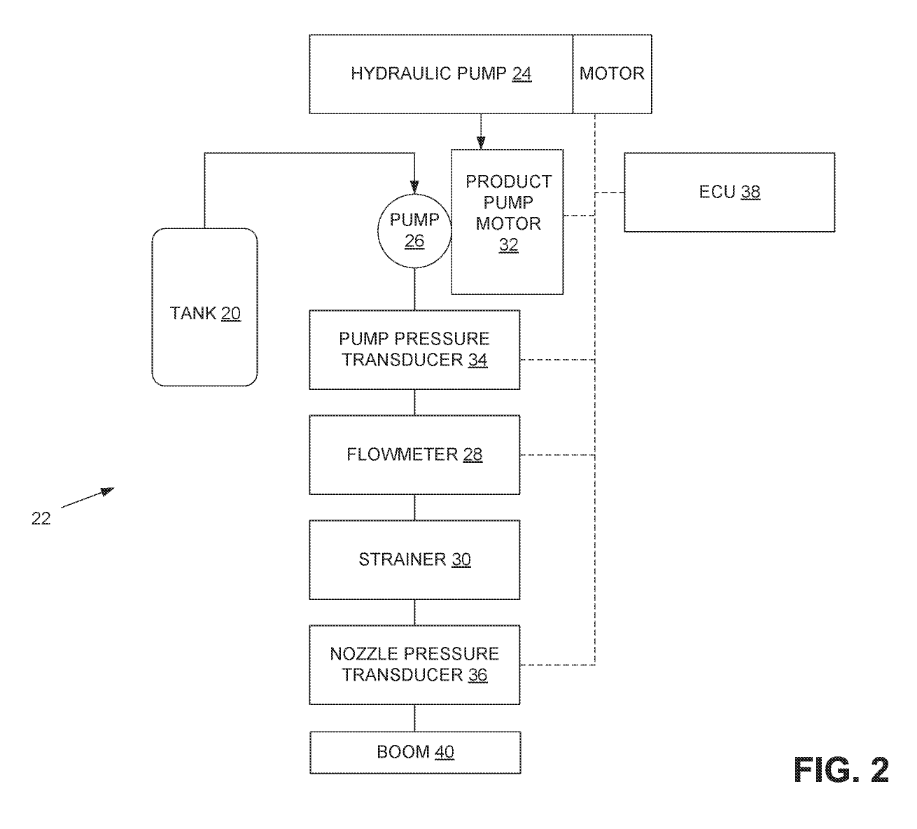

Reference is made to FIG. 1, which illustrates in overhead view an example mobile machine 10 in which an embodiment of a product dispensing diagnostic system 12 may be used. In the depicted example, the mobile machine 10 is embodied as a self-propelled sprayer, though it should be appreciated by one having ordinary skill in the art in the context of the present disclosure that the mobile machine may be embodied as any one of a plurality of product dispensing (e.g., dispensing of pesticides, seeds, fertilizer, water, etc. to soil or other surfaces) mobile machines in the same or different industry, and hence are contemplated to be within the scope of the disclosure. For instance, in some embodiments, the mobile machine 10 may be composed of a tractor-trailer arrangement where the sprayer assembly is towed behind the tractor. In the example embodiment depicted in FIG. 1, the mobile machine 10 comprises a front hood 14, front and rear wheels 16 (though tracts may be used in some embodiments and/or different axle arrangements), a cab 18, a reservoir 20 (e.g., tank) that stores product and which rests upon (or is mounted to) a chassis of the mobile machine 10, and a product dispensing system comprising a circuit 22 having a plurality of components. For instance, and referring also to FIG. 2 (where solid lines represent tubular members 23 through which product (or hydraulic fluid in the case of the connection between the hydraulic pump and the product pump motor) flows and dashed lines refer to a signal bus or busses, such as an ISO-bus (e.g., twisted pair wiring, etc.) of a controller area network (CAN)), the hydraulic pump 24, which includes a motor, serves as a source of power for the product pump 26. The circuit 22 may include a product pump 26 (or pumps, such as a centrifugal pump(s)), a flowmeter 28 (or flowmeters), and a strainer 30 (or strainers). In some embodiments, the circuit 22 may also include components that may not directly be exposed to the product, such as the product pump motor 32, or other components that may be exposed to the product, such as one or more pump pressure transducer (one shown for brevity, pump pressure transducer 34) and one or more nozzle pressure transducers 36 (one shown for brevity, nozzle pressure transducer 36). Note that in some embodiments, the transducers 34 and/or 36 may be replaced with equivalent devices from which the pressures may be derived.

Also shown is an electronics control unit (ECU) 38, which receives Inputs from the hydraulic pump motor, the product pump motor 32, the pump pressure transducer 34, the flowmeter 28, and the nozzle pressure transducer 36, collectively referred to in one embodiment as the product dispensing diagnostic system 12, though some embodiments may have fewer or additional components. The ECU 38 uses the inputs from these components to help identify when the components of or associated with the circuit 22 are performing below an expected (e.g., optimum) efficiency that requires operator action, such as to unplug or replace the offending component(s). Note that in some embodiments, additional input may be used in diagnosing the system, such as inputs involving the type of nozzles being used, such as to enable a determination as to whether the nozzle sizing is appropriate for the application, and/or pressure (e.g., via a pressure transducer used in association with the hydraulic pump 24), among other inputs.

Note that additional components may be included in the circuit 22, including valves (e.g., shut-off valves, control valves, agitator valves, regulating valves, throttling valves, etc.), fittings (e.g., tee fittings, etc.), and/or additional strainers in other locations (e.g., a line strainer between the centrifugal pump and tank 20), as should be appreciated by one having ordinary skill in the art.

Also, note that one or more of the aforementioned components may reside on a truss-like structure referred to as a boom 40 (FIGS. 1 and 2), such as nozzles, the corresponding nozzle pressure transducers 36, and a portion of the tubular members 23 of the circuit 22. The boom 40 may be retractable, raised and lowered, and/or foldable in some embodiments. Further, the boom 40 may comprise plural, independently controlled sections, with each section comprising one or more nozzles or nozzle groups. As is known, each nozzle may be configured with a rotatable actuator (mechanically or electrically actuated) which enables automated selection (e.g., by a computer) of a nozzle type among a selectable group of nozzles at each nozzle location. For instance, each nozzle of a given group, at a given location along the boom 40, may differ in nozzle performance, such as flow pattern, or be distinguished based on the type of product to flow therethrough. As nozzles are well-known to those having ordinary skill in the art, further discussion of the same is omitted for brevity. Note that the configuration and connection of components depicted in FIG. 2 is but one example for illustrative purposes, and that variations are contemplated to be within the scope of the disclosure. For instance, in some embodiments, a recirculation line may couple the tank to the boom 40 (e.g., for product recovery).

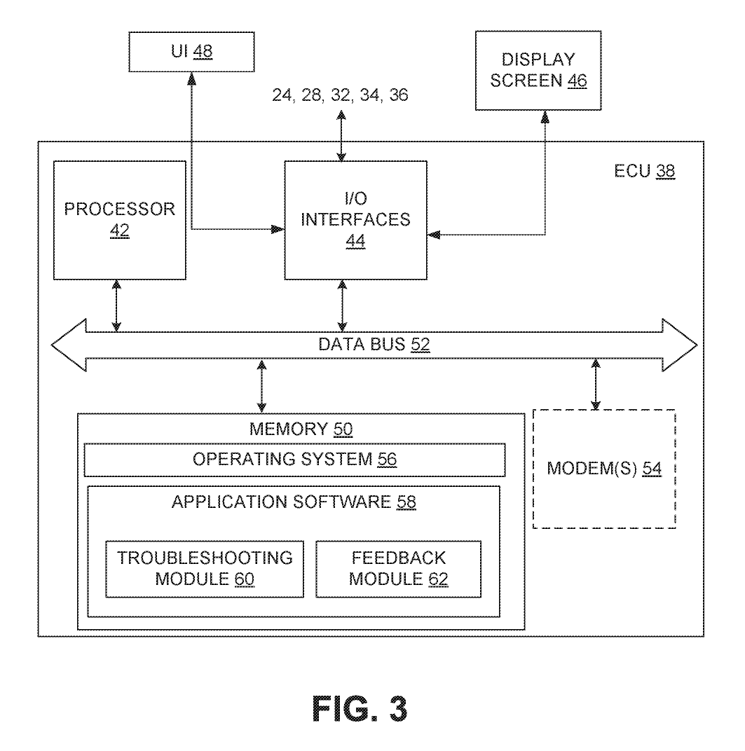

Attention is now directed to FIG. 3, which illustrates an example configuration for the ECU 38 depicted in FIG. 2. One having ordinary skill in the art should appreciate in the context of the present disclosure that the example ECU 38 is merely illustrative of one embodiment, and that some embodiments of ECUs may comprise fewer or additional components, and/or some of the functionality associated with the various components depicted in FIG. 3 may be combined, or further distributed among additional modules or computing devices (e.g., ECUs) in some embodiments. The ECU 38 is depicted in this example as a computer system, but in some embodiments may be embodied as a programmable logic controller (PLC), field programmable gate array (FPGA), application specific integrated circuit (ASIC), among other devices. It should be appreciated that certain well-known components of computer systems are omitted here to avoid obfuscating relevant features of the ECU 38. In one embodiment, the ECU 38 comprises one or more processors, such as a processor 42, input/output (I/O) interface(s) 44, which in one embodiment are coupled to a display screen 46 and other user interfaces (UI) 48, and memory 50, all of which are coupled to one or more data busses, such as data bus 52. Also shown is an optional modem(s) 54 (e.g., cellular modem and/or radio modem) that enables, in association with local communications and/or browser software, access to a cellular network and the Internet or other networks (e.g., local networks). In some embodiments, the display screen 46 and/or user interfaces 48 may be coupled directly to the data bus 52. The memory 50 may include any one or a combination of volatile memory elements (e.g., random-access memory RAM, such as DRAM, SRAM, SDRAM, etc.) and nonvolatile memory elements (e.g., ROM, hard drive, Flash, EPROM, EEPROM, CDROM, etc.). The memory 50 may store a native operating system, one or more native applications, emulation systems, or emulated applications for any of a variety of operating systems and/or emulated hardware platforms, emulated operating systems, etc. In some embodiments, a separate storage device may be coupled to the data bus 52, such as a persistent memory (e.g., optical, magnetic, and/or semiconductor memory and associated drives).

In the embodiment depicted in FIG. 3, and with continued reference also to FIGS. 1-2, the memory 50 comprises an operating system 56 and application software 58. The application software 58 comprises executable code, including a troubleshooting module 60 and a feedback module 62. It should be appreciated by one having ordinary skill in the art in the context of the present disclosure that the ECU 38 may embody other mechanisms of control in some embodiments, such as a more rudimentary form of control or a reduced set of executable modules. The application software 58, as executed by the processor 42, receives input via the I/O interfaces 44 from the flowmeter 28, the product pump motor 32, the hydraulic pump motor 24, the pump pressure transducer 34, and the nozzle pressure transducer 36. As noted previously above, additional inputs may be received, such as inputs corresponding to a nozzle type currently in use. The Inputs to the ECU 38 from the respective components via the I/O interfaces 44 include motor speed, hydraulic pump motor speed (and/or pressure), pump pressure, flow, and nozzle pressure. It should be appreciated by one having ordinary skill in the art in the context of the present disclosure that one or more of the aforementioned inputs may be received via an intermediary device involved in the generation and/or processing of the input signal. For instance, the input from the product pump motor 32 may be via a magnetic (or other type) sensor coupled to the product pump motor 32, where the sensor in turn may format the signal or provide the signal to a signal processing device (e.g., amplifier, filter, analog-to-digital converter) for formatting and/or signal conditioning before being received at the ECU 38. In some embodiments, the signal conditioning and/or formatting may be achieved by hardware and/or software in the ECU 38.

The application software 58 also receives input from the user interfaces 48, and outputs signals to the user interfaces 48 and/or the display screen 46 via the I/O interfaces 44. The application software 58, and in particular, the troubleshooting module 60, uses the input signals from the flowmeter 28, the product pump motor 32, the hydraulic pump motor, the pump pressure transducer 34, and the nozzle pressure transducer 36 to perform diagnostics on components of the circuit 22 (FIG. 2), as described further below. In some embodiments, additional input may include hydraulic pump pressure, nozzle type, etc.

The application software 58 also, through the use of the feedback module 62, renders a visual and/or aural representation of the results of the diagnostics performed by the troubleshooting module 60 via the display screen 46 and the user interfaces 48, respectively. For instance, the feedback module 62, through execution by the processor 42 and based on a determination by the troubleshooting module 60, may render an alert of a problem with one or more components, an identification of the component or components causing the problem, a severity of the problem, and instructions on how to address (e.g., fix) the problem. The feedback module 62 may render different types of alerts based on the severity of the problem, such as a difference in instructions, a difference in the color or format of the alert, etc. For instance, if the troubleshooting module 60 determines that pump wear (e.g., of the impellor of the product pump 26) is at level midway in the tolerable range of operation degeneration, the level may be communicated to the feedback module 62, which in turn presents a cautionary alert to the operator (e.g., via the display screen 46) that the pump is wearing out and has an expected usable life of some determined data in the future (e.g., based on historical data or predictive software). In contrast, if the degeneration of the product pump 26 has surpassed (fallen below) the tolerable range of operation, a more dire warning is presented to the operator and possible other actions, such as recommendations to replace the pump 26 and an identification of ordering information (or in some embodiments, auto-ordering with confirmation or a permission request to enable auto-ordering presented to the operator). The feedback to the operator may also be via an aural instruction and/or alert, such as via a speaker of the user interfaces 48. In either or any case (visual, aural or both), the feedback module 62 also presents instructions on how to fix, or generally, how to address the problem. For instance, the feedback module 62 may present a graphic of the circuit 22 (FIG. 1) and identify the component and its location in the circuit 22. In some embodiments, the graphic may be omitted and the instruction and/or alert is limited to text or audible instructions. The instructions may be to unplug a component of the circuit (and how to perform this service), replace a component of the circuit (and how to perform this service), or contact a service technician or representative or dealer representative.

In some embodiments, the feedback module 62, as suggested above, may also be responsible for ordering replacement parts. The feedback module 62 may cause an ordering process to be automatically (or semi-automatically) achieved through use of a data structure stored in memory 50 (or elsewhere, such as remotely), where the feedback module 62 (or troubleshooting module 60, or both) identifies the part number of the offending component, and communicates with a dealer or service entity via the modems 54 (e.g., where contact information and ordering or part number information is stored in the data structure). The feedback module 62 may implement this order when the range of operation is beyond tolerable limits (e.g., beyond a threshold value), or at other stages of component degeneration in some embodiments. As noted above, the ordering may be achieved automatically (e.g., transparent to the operator, at least until the order is complete), or semi-automatically (e.g., with operator intervention, such as alerting the operator that the order is in progress and affording the operator an opportunity to accept or deny the order initiation). In some embodiments, the operator may be provided a confirmation of the order by the feedback module 62.

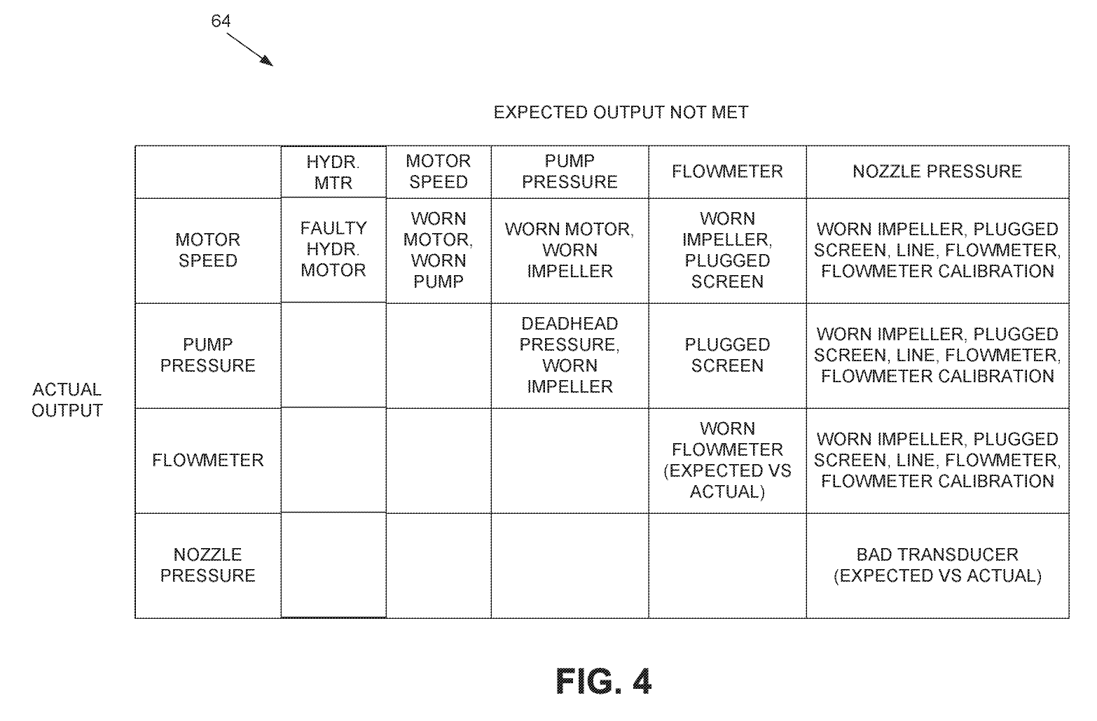

In one embodiment, the troubleshooting module 60 operates according to a troubleshooting tree 64, as shown schematically in FIG. 4. The troubleshooting tree 64 comprises expected output not met and actual output. With continued reference to both FIGS. 2-4, the troubleshooting module 60 receives hydraulic pump motor speed (Hydr. Mtr.) input, product pump motor speed input, pump pressure, flow, and nozzle pressure from the product pump motor 32, pump pressure transducer 34, flowmeter 28 (e.g., from I/O ports on the flowmeter 28 that provide a signal(s) indicating number of revolutions of the flowmeter blades or paddles via pulsed outputs that are calibrated by the ECU 38 or an intermediary device to flow volume), and the nozzle pressure transducer 36, respectively. Each of these inputs is processed concurrently and in a continual manner by the troubleshooting module 60 according to an algorithm corresponding to the logic or scheme of the troubleshooting tree 64. In some embodiments, the inputs may be processed by the troubleshooting module 60 periodically or aperiodically. The troubleshooting tree 64 enables an identification of issues with the intended operation that require action by the operator. The product pump motor 32, hydraulic pump motor, pump pressure transducer 34, flowmeter 28, and the nozzle pressure transducer 36 provide their respective inputs that are assessed in combination with all of the inputs from these components, and based on a comparison of actual and expected values associated with the inputs, the assumptions of possible causes conveyed in the troubleshooting tree 64 can be detected. Notably, it is the assessment of all of the inputs in an as-a-whole manner of processing that enables an identification of problems in the circuit 22 (FIG. 2) in a clear and concise manner. For instance, if the motor speed, such as the hydraulic motor speed, is not considered in the processing, diagnosis is diminished because the hydraulic motor (which comprises a variable displacement motor with a corresponding electronic signal to drive its function) is not identified as an issue. Similarly, if the pump pressure was not an input, diagnosis is diminished because the product pump impeller is not identified as an issue. The absence of flowmeter and nozzle pressure inputs render the diagnosis less accurate, since more assumptions are made, which may lead to more vague and less concise results.

As noted from the troubleshooting tree 64, using variable control of the hydraulic pump, if the motor speed does not match the expected output given the expected flow, it can be suggested that the hydraulic motor is at fault. If the motor speed input does not relatively match the expected outcome then the troubleshooting tree 64 suggests a worn motor or worn pump. When the pump pressure input does not match what is expected given the motor speed, a worn motor or worn impeller can be suggested, or based on a deadhead pressure test (considering pump pressure alone), a worn impeller. The flowmeter input (expected versus actual readings), alone, may suggest a worn flowmeter, or when considered with the pump pressure, a plugged screen, and when considered with the motor speed, a worn impellor or plugged screen. The nozzle pressure input alone (e.g., expected versus actual readings) suggests a bad transducer, but when assessed with the flowmeter inputs or pump pressure inputs, suggests a worn impellor, plugged screen, plugged line (e.g., plugged tubular member 23 (FIG. 2, or members), plugged flowmeter, or fault (erroneous) flowmeter calibration. The nozzle pressure input in conjunction with the motor speed input suggests a worn impellor, plugged screen, plugged line, plugged flowmeter, or faulty flowmeter calibration. Values that indicate problems (e.g., a value of the input has a threshold difference from respective predetermined values) is interpreted by the troubleshooting module 60 as raising a potential issue as described in the troubleshooting tree 64. In other words, if the actual value corresponding to the motor speed input falls outside a predetermined range of acceptable (predetermined) motor speed values, then the troubleshooting module 60 determines that there exists a worn motor or worn pump. All of the inputs are processed concurrently and in real-time (on-going, or periodically or aperiodically in some embodiments), enabling a process of elimination that is a quick and efficient assessment or diagnosis of the components of the circuit 22.

Referring again to FIG. 3, execution of the application software 58 (and its associated modules 60 and 62) may be implemented by the processor 42 under the management and/or control of the operating system 56. In some embodiments, the operating system 56 may be omitted and a more rudimentary or reduced manner of control implemented. The processor 42 may be embodied as a custom-made or commercially available processor, a central processing unit (CPU) or an auxiliary processor among several processors, a semiconductor based microprocessor (in the form of a microchip), a macroprocessor, one or more application specific integrated circuits (ASICs), a plurality of suitably configured digital logic gates, and/or other well-known electrical configurations comprising discrete elements both individually and in various combinations to coordinate the overall operation of the ECU 38.

The I/O interfaces 44 comprise hardware and/or software to provide one or more interfaces to a network or networks within the mobile machine 10 (FIG. 1), such as one or more CAN busses. In other words, the I/O interfaces 44 may comprise any number of interfaces for the input and output of signals (e.g., analog or digital data) for conveyance of information (e.g., data) over such local networks. For instance, as described above, the I/O interfaces 44 enable communication between the ECU 38 and the components 24, 28, 32, 34, and 36 of the circuit 22 (FIG. 2), as well as between the display screen 46 and user interfaces 48. Note that in some embodiments, other inputs may be received depending on the circuit arrangement, such as input from valves, pressure inputs from the hydraulic pump 24, nozzle type, etc. The I/O interfaces 44 also enable input via the user interfaces 48, which may be embodied as one or a combination of a keyboard, mouse, microphone, speaker, steering wheel, multi-functional handle, or other devices (e.g., switches, immersive head set, etc.) that enable input and/or output by an operator (e.g., to respond to indications presented on the screen or aurally presented when not responding directly using the display screen 46).

In one embodiment, the display screen 46 may be embodied as a touch screen-type display, though not limited to such a design. The display screen 46 may be configured according to any one of a variety of technologies, including cathode ray tube (CRT), liquid crystal display (LCD), plasma, haptic, among others well-known to those having ordinary skill in the art. In some embodiments, the functionality of the display screen 46 and/or user interfaces 48 may, at least in part, be performed via an electronic device in wireless or wired communication with the ECU 38, such as a portable communications device (e.g., smartphone, personal digital assistant (PDA), etc.).

In some embodiments, functionality of the application software 58 may be implemented remotely from the mobile machine 10 (FIG. 1), such as in an autonomous or semi-autonomous spraying environment. Such functionality may be enabled via a remote server(s) and the modems 54 of the ECU 38. In some embodiments, the modems 54 may be external to the ECU 38 yet coupled via a CAN bus.

When certain embodiments of the ECU 38 are implemented at least in part with software (including firmware), as depicted in FIG. 3, it should be noted that the software (e.g., such as the application software 58 and its associated modules 60 and 62) can be stored on a variety of non-transitory computer-readable medium for use by, or in connection with, a variety of computer-related systems or methods. In the context of this document, a computer-readable medium may comprise an electronic, magnetic, optical, or other physical device or apparatus that may contain or store a computer program (e.g., executable code or instructions) for use by or in connection with a computer-related system or method. The software may be embedded in a variety of computer-readable mediums for use by, or in connection with, an instruction execution system, apparatus, or device, such as a computer-based system, processor-containing system, or other system that can fetch the instructions from the instruction execution system, apparatus, or device and execute the instructions.

When certain embodiments of the ECU 38 are implemented at least in part with hardware, such functionality may be implemented with any or a combination of the following technologies, which are all well-known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), relays, contactors, etc.

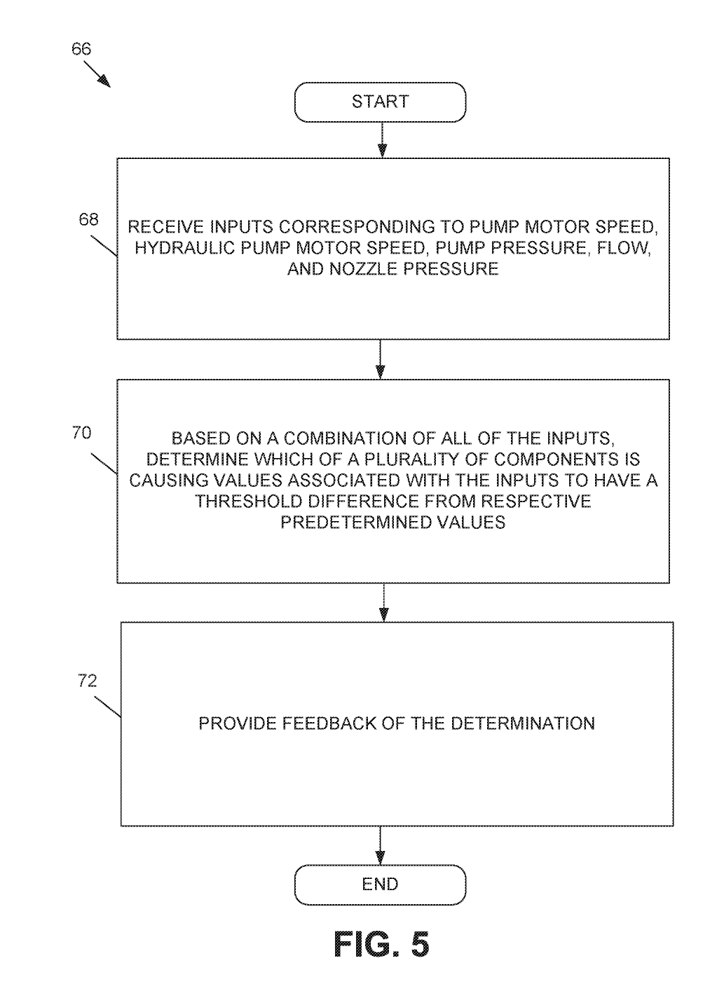

In view of the above description, it should be appreciated that one embodiment of an example product dispensing diagnostic method 66, as depicted in FIG. 5, comprises: receiving inputs corresponding to a pump motor speed, hydraulic pump motor speed, pump pressure, flow, and nozzle pressure (68); based on a combination of all of the inputs, determining which of a plurality of components is causing values associated with the inputs to have a threshold difference from respective predetermined values (70); and providing feedback of the determination (72).

Any process descriptions or blocks in flow diagrams should be understood as representing modules, segments, or portions of code which include one or more executable instructions for implementing specific logical functions or steps in the process, and alternate implementations are included within the scope of the embodiments in which functions may be executed out of order from that shown or discussed, including substantially concurrently or in reverse order, depending on the functionality involved, as would be understood by those reasonably skilled in the art of the present disclosure.

In this description, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the present technology can include a variety of combinations and/or integrations of the embodiments described herein. Although the systems and methods have been described with reference to the example embodiments illustrated in the attached drawing figures, it is noted that equivalents may be employed and substitutions made herein without departing from the scope of the disclosure as protected by the following claims.

At least the following is claimed:

1. A diagnostic system for a mobile product dispensing machine comprising:
a plurality of nozzles;
a hydraulic pump;
a circuit coupled to the plurality of nozzles, the circuit comprising tubular members, a pump, a screen, and a plurality of first components coupled to the tubular members, the plurality of first components comprising:
a pump motor;
a pump pressure transducer;
a flowmeter; and
a nozzle pressure transducer; and
an electronic control unit coupled to the circuit, the electronic control unit configured to receive inputs associated with a motor of the hydraulic pump and each of the plurality of first components and based on a combination of all of the inputs, determine whether one or a combination of the pump, the pump motor, the hydraulic pump, the hydraulic pump motor, the screen, the flowmeter, the nozzle pressure transducer, or at least a portion of the tubular members is causing values associated with the inputs to have a threshold difference from respective predetermined values, and provide feedback of the determination.

2. The system of claim 1, wherein at least a portion of the inputs corresponds to a motor speed of the pump motor and a motor speed of the hydraulic pump motor.

3. The system of claim 1, wherein one of the inputs corresponds to a discharge pump pressure.

4. The system of claim 3, wherein the discharge pump pressure comprises a dead-head pump pressure.

5. The system of claim 1, wherein one of the inputs corresponds to an actual flow reading, wherein the electronic control unit is further configured to compare the actual flow reading with an expected flow reading.

6. The system of claim 1, wherein one of the inputs corresponds to a nozzle pressure, nozzle type, or a combination of nozzle pressure and nozzle type, wherein the electronic control unit is further configured to compare the actual nozzle pressure with an expected nozzle pressure.

7. The system of claim 1, wherein the electronic control unit is configured to provide feedback by presenting an indication that one or more of the values has the threshold difference based on one or more of the following: a worn motor, a worn hydraulic pump motor, a worn pump, a plugged screen, a worn flowmeter, a plugged tubular member, an erroneous flowmeter calibration, or a bad transducer.

8. The system of claim 1, wherein the electronic control unit is configured to determine based on concurrent and continual processing of the inputs.

9. The system of claim 1, further comprising a telemetry device coupled to the electronic control unit, the electronic control unit configured to determine, based on the determination of the threshold difference, a part number of one or more of the pump, the hydraulic pump, the pump motor, a hydraulic pump motor, the screen, the flowmeter, the nozzle pressure transducer, or at least the portion of the tubular members and cause the telemetry device to transmit a purchase order comprising part number for a replacement part or replacement parts to a remote computer.

10. The system of claim 1, further comprising a display screen coupled to the electronic control unit, the electronic control unit configured to provide visual feedback of the determinations via the display screen.

11. The system of claim 1, further comprising a speaker coupled to the electronic control unit, the electronic control unit configured to provide aural feedback of the determinations via the speaker.

12. The system of claim 1, wherein the feedback comprises one or any combination of an alert of a problem, an identification of the component or components causing the problem, a severity of the problem, and instructions on how to address the problem.

13. The system of claim 1, wherein the electronic control unit determines by evaluating a troubleshooting tree comprising a matrix of the inputs and assumptions of possible causes.

14. An electronic control unit comprising a processor configured to receive inputs corresponding to a pump motor speed, a hydraulic pump motor speed, a pump pressure, flow, and nozzle pressure and based on a combination of all of the inputs, determine which of a plurality of components is causing values associated with the inputs to have a threshold difference from respective predetermined values, and provide feedback of the determination.

15. The electronic control unit of claim 14, wherein the plurality of components comprises a pump, a hydraulic pump, a pump motor, a screen, a flowmeter, a nozzle pressure transducer, at least one tubular member coupled in a circuit.

16. The electronic control unit of claim 14, wherein the processor is configured to provide feedback by presenting an indication that one or more of the values has the threshold difference based on one or more of the following: a worn motor, a worn hydraulic pump motor, a worn pump, a worn hydraulic pump, a worn impeller, a plugged screen, a worn flowmeter, a plugged tubular member, a flawed flowmeter calibration, or a bad transducer.

17. The electronic control unit of claim 14, wherein the processor is configured to determine based on concurrent and continual processing of the inputs.

18. The electronic control unit of claim 14, wherein the feedback comprises one or any combination of an alert of a problem, an identification of the component or components causing the problem, a severity of the problem, and instructions on how to address the problem.

19. The electronic control unit of claim 14, wherein the processor is configured to determine based on evaluating a troubleshooting tree comprising a matrix of the inputs and assumptions of possible causes.

20. A method, comprising:
receiving inputs corresponding to a pump motor speed, a hydraulic pump motor speed, pump pressure, flow, and nozzle pressure;
based on a combination of all of the inputs, determining which of a plurality of components is causing values associated with the inputs to have a threshold difference from respective predetermined values; and
providing feedback of the determination.
